(19) United States
(12) Patent Application Publication
(10) Pub. No.: US 2003/0167622 A1
(43) Pub. Date: Sep. 11, 2003

(54) Construction of dies

(76) Inventor: Laurence David Cook, Essex (GB)

Correspondence Address: SMITH-HILL AND BEDELL, 12670 N W BARNES ROAD, SUITE 104, PORTLAND, OR, 97229

(21) Appl. No.: 10/276,821

(22) PCT Filed: May 14, 2001
(86) PCT No.: PCT/GB01/02108

(30) Foreign Application Priority Data
May 16, 2000 (GB) 0011671.5

(51) Int. Cl. B23P 11/00; B23P 19/00

(52) U.S. Cl. 29/525.11; 29/525.01; 29/428; 29/700

(57) ABSTRACT

A method of positioning dies on the bed of a press is disclosed which comprises providing a support plate to overlie the surface of the bed of the press and having through apertures in alignment with anchoring holes formed in the bed of the press. Individual dies are placed in desired positions over the support plate and anchored to the bed at the same time as the support plate by inserting and tightening dogs into the aligned apertures in the support plate and anchoring holes in the bed. After the correct dies have been correctly aligned on the bed, they are secured to the support plate by means of screws. The dies remain attached to the support plate after they have been removed from the bed so that when a new run is required there is no need to repeat the alignment procedure.

The present invention is applicable to the construction of dies for use for example in hot foil blocking and embossing.

There are several applications where a sheet is pressed against a die in order to make an impression on the sheet. In hot foil blocking, for example, a foil is pressed by means of a heated die to apply a coating made of or resembling a metal foil to selected regions of a carrier sheet. In embossing, a carrier sheet is compressed between complementary male and female dies to achieve the desired raising of selected regions of the sheet from its plane.

Presses used in such applications comprise two horizontal beds to which the dies are secured, the upper bed being pneumatically operated. In operation, the beds are separated by raising the upper bed and/or lowering the lower bed, a carrier sheet is introduced between the two beds, the beds are brought together to make the desired impression on the carrier sheet and finally the carrier sheet on which an impression has been made is removed and replaced by the next carrier sheet.

Such presses are required to operate at high speed and in order to reduce the time taken to complete a given run, it is usual to make numerous impressions on different areas of a carrier sheet all at the same time. For example, if an area of gold lettering is to be applied to a small cardboard package, then the blanks for several such packages may be formed on a single large sheet of cardboard which is cut into individual blanks after the printing and foil blocking operations have been completed.

In such an application, it is not cost effective to produce a single die to make the multiple impressions as such a die would in the first place be prohibitively expensive and furthermore the entire die would need to be replaced if any part of it were to be damaged. For this reason, several separate dies are produced and they are all individually mounted on the bed or beds of the press.

To this end, the beds of the press are formed as thick sheets of steel having a regular matrix of anchoring holes. Expanding pegs, referred to in the art as dogs, grip within these holes and are used to anchor the individual dies to the bed. The dies are themselves usually made of a copper plate onto which the desired pattern has been formed by a photographic etching process that is well known in itself and need not be described within the context of the present invention.

Conventionally, all the individual dies are positioned on the beds using dogs and a test is run to ensure that their position is in register with the existing markings on the cardboard carrier sheets. Adjustments are made to the individual dies and the test procedure is repeated until all the dies are in their correct position. This setting up of the dies may take several hours. At the end of a run, the dies are removed to allow the same press to be used for another job and should a fresh run later be required, the setting up procedure of the dies must be repeated.

The present invention seeks to avoid the need for expensive and time consuming re-alignment of the dies on the bed of a press prior to commencement of each run.

According to a first aspect of the present invention, there is provided a method of positioning dies on the bed of a press, which comprises providing a support plate to overlie the surface of the bed of the press and having through apertures in alignment with anchoring holes formed in the bed of the press, placing individual dies in desired positions over the support plate, anchoring the dies and the support plate to the bed of the press by inserting and tightening dogs into the aligned apertures in the support plate and anchoring holes in the bed and securing the dies to the support plate.

In the present invention, when the dogs are removed to allow the dies to be replaced, the dies remain attached to the support sheet and they are taken off the bed of the press while still attached to their support sheet. In this way, the relative positions of the dies on the support sheet will be preserved and if a new run should be required then it is only necessary to place the support sheet complete with the dies back on the bed of the press.

It is preferred to secure the dies to the support sheet in a manner that permits a limited degree of lost motion. To this end, it is preferred to drill holes in the dies and to secure the dies to the support plate by screws that are a loose fits in the holes. In this way, the screws can be loosened during the alignment process to allow a small degree of movement of the dies. Thereafter, once the screws are tightened they will retain the dies firmly in the correct position. The force of the screws will not however be sufficient to withstand the forces of relative thermal expansion of the copper and the steel and they will therefore avoid any danger of distortion of the dies on that account.

In accordance with a second aspect of the invention, there is provided a die assembly for forming multiple impressions on a carrier, the assembly comprising a plurality of individual dies secured in predetermined positions to a common support plate, the support plate having a matrix of apertures for receiving dogs for retaining the die assembly on the bed of a press.

To avoid modification to the bed of the press, the combined thickness of the dies and the support plate is preferably equal to the thickness of a conventional die, being typically 6.35 mm. To this end, it is preferred that the dies should have a thickness of 4.35 mm and the support plate a thickness of 2 mm.

The diameter of the apertures in the support plate is preferably slightly larger than the diameter of the holes in the bed of the press to allow for slight variations.

The apertures may conveniently be stamped in the support sheet and the support sheet may be ground to remove any protrusions formed around the edges of the apertures by the stamping. The ends of the screws securing the dies to the support plate may also be ground flush with the surface of the support sheet.

The invention will now be described further, by way of example, with reference to the accompanying drawings, in which:

FIG. 1 is a schematic plan view of a bed of a press supporting six identical dies,

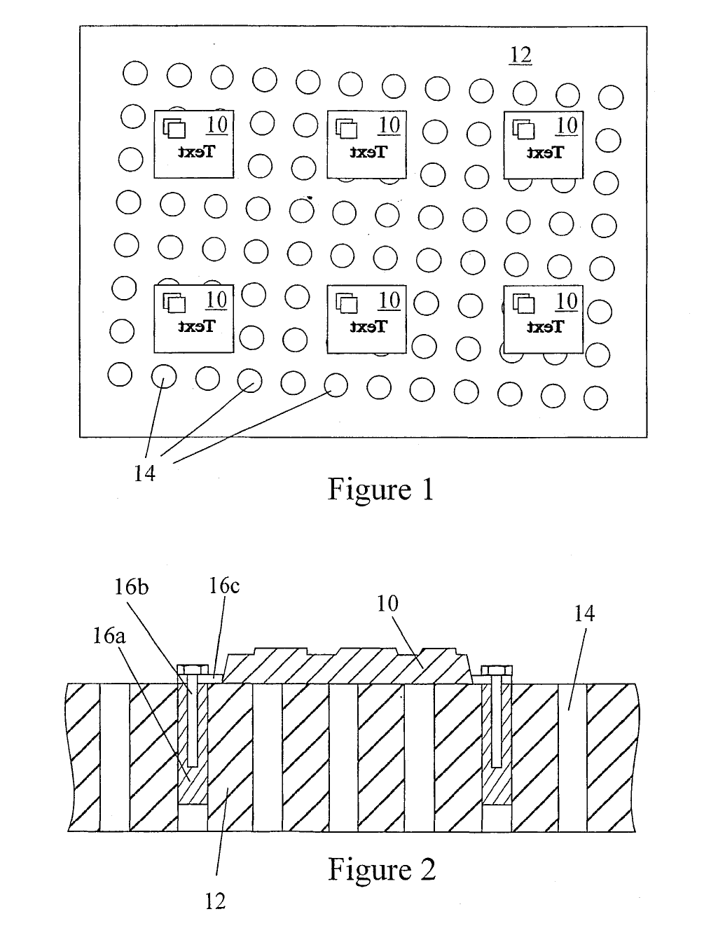

FIG. 2 is section through the bed and one of the dies illustrating the conventional manner of securing the dies in position on the bed,

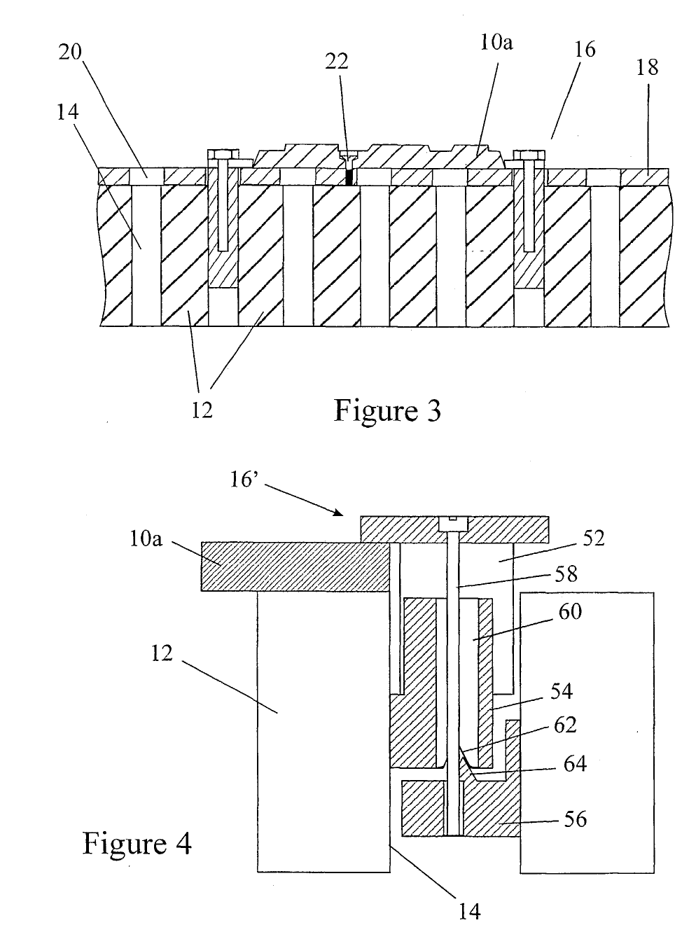

FIG. 3 is a section similar to that of FIG. 2 showing an embodiment of the present invention,

FIG. 4 is a detail of a section similar to that of FIG. 3 showing an alternative construction of the dogs used to anchor the dies onto the bed of the press, and

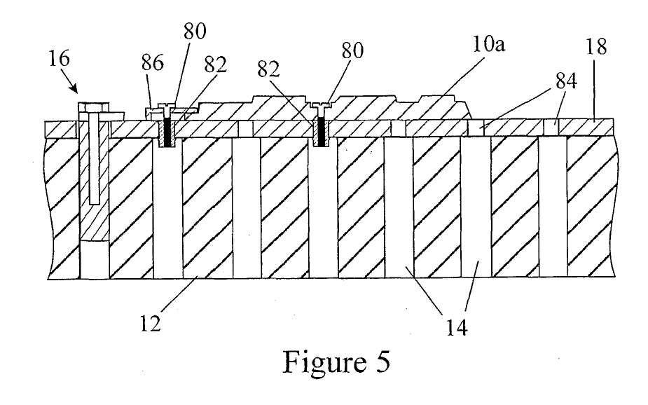

FIG. 5 is a view similar to that of FIG. 3 showing an alternative embodiment of the invention.

In FIG. 1, six dies 10 are supported on the bed 12 of a press. Each die 10, which is to be used for example to impress a metal onto a carrier sheet, has a raised pattern that is shown as comprising the word Text (in reverse) and a logo of two overlapping squares. The bed 12 of the press has a regular matrix of holes 14 for receiving dogs 16 (shown in FIGS. 2 to 4) that anchor the dies 10 on the bed 12. To ensure that there is always an exposed hole 14 for receiving a dog 16 adjacent each side of the dies, the matrix of holes is inclined relative to the sides of the dies 10 and the bed 12. It should be mentioned that the drawings are only schematic and do not show the various parts to scale.

In FIG. 2, it can be seen that the dies 10 have sloping side edges that are gripped by the dogs 16. Each dog 16 consists of an expanding plug 16a that is inserted into a hole 14 in the bed 12, and an eccentric plate 16c that rotates about a bolt 16b received in the plug 16a. After insertion of the plug 16a into an available hole 14, the plate 16c is rotated until it makes contact with the die 10 and as bolt 16b is tightened in the plug 16a. The tightening of the bolt 16b causes the plug 16a to expand, making it grip the hole 14, and the bolt head presses down on the eccentric plate 16c to hold the die 10 in position on the bed 12. Dogs are inserted into the holes 14 in the bed to hold each die 10 on all sides.

Conventionally, after the dies have been mounted in the above manner, a test run is carried out to ensure that the dies are in their desired positions. If a die is slightly out of position, its dogs are loosened, it is moved as desired, and the dogs are re-tightened. The eccentricity of the plates 16c affords a certain latitude and when a plate 16c is at the limit of its adjustment range then the spacing of the holes 14 is such that the die can be gripped by moving the dog to an adjacent hole. This allows the dies 10 to be accurately located on the bed 12 in any desired position, but setting up the dies 10 prior to a run may take a considerable time, typically several hours.

In the present invention, as shown in FIG. 3, a support sheet 18 is interposed between the dies 10a and the bed 12. The support sheet 18 has apertures 20 that are of slightly greater diameter than the holes 14 in the bed 12 and are aligned with the holes 14 in the bed 12. Once the support sheet 18 has been placed over the bed 12, a dog 16 can be inserted into any of the holes 14 through the overlying aperture 20 so that the support sheet 18 does not interfere in any way with the positioning of the dies 10a. If the dies 10a are made thinner that the convention dies 10 by an amount equal to the thickness of the support plate 18, then no modification of any sort is required to the press nor to the bed 12.

An alternative construction of the dogs is shown in FIG. 4 where the dog is generally designated 16′. The dog comprises a plate 50 which two opposed flats to enable it to be gripped using a spanner. A pair of parallel cheeks 52 extend from the underside of the plate 50 into the hole 14 in the bed 12. These straddle the flat sides of a first clamping member 54 that can move sideways within the hole 14 without rotating relative to the plate 50. A second clamping member 56 lies beneath the first clamping member 54 in the hole 14 and is connected to the plate 50 by a screw 58 that passes with clearance through an elongated slot 60 that traverses the length of the first clamping member. The facing surfaces are of the two clamping member 54 and 56 are formed with cam surfaces in the form of a triangular groove 62 and a triangular projection 64, respectively that urge the clamping member 54 and 56 apart in a direction perpendicular to the axis of the hole 14 when they are axially squeezed together. The dog 16′ in operation is inserted into the hole 14 with the plate 50 positioned in the same manner as in FIG. 3. While the plate 50 is gripped with a spanner to prevent it from rotating, the screw 58 is driven into the second clamping member 56 until all three parts of the dog come to rest against each other, with the lower edges of the cheeks 52 resting on a shoulder of the first clamping member 54. Further tightening of the screw 58 causes the cam surfaces of the clamping members to slide over one another urging the clamping members apart to grip the walls 14 firmly. Further rotation of the screw 58 tightens the support sheet 18 firmly onto the bed 12 of the press.

When producing the first run from a set of dies, the support sheet 18 is placed over the bed and the dogs 16 are then positioned on the support sheet 18 in the manner previously described. However, once the dies have been correctly set up, they are secured to the support sheet 18 using screws 22 (preferably self-tapping), the heads of which are recessed beneath the top surface of the dies 10a. These screws 22 are sufficient to retain the location of the dies 10a on the support sheet 18 but will allow the dies and the support sheet to expand at different rates when heated to avoid the support sheet 18 being distorted by the stresses. In this respect, the holes in the dies 10a for the screws 22 have a larger diameter than the shanks of the screws 22 to permit a small amount of relative movement.

At the end of the first run, once the dogs 16 have been removed, it is possible to remove the support sheet 18 from the bed of the press with the dies 10a attached. The sheet 18 and the attached dies 10a may be stored in this way so that when another run of impressions is needed, the dies 10a will be correctly pre-aligned on the bed 12. It is necessary only to place the support sheet 18 on the bed 12 with it apertures aligned with the holes 14 in the bed 12 and to insert dogs 16 around the dies 10. In this way, it is possible to avoid the need for extensive and time consuming readjustments to the positions of the dies 10a at the commencement of each run.

It is desirable to clamp at least one edge of the support sheet 18 between a pair of clamping bars when the support sheet 18 is removed from the press. Such a pair of clamping bars serves to add rigidity to the sheet to prevent it from bending. The clamping bars can also serve as a convenient means for suspending the support plate 18 and the dies 10a in a storage rack. If the clamping bars are sufficiently thick they will act as spacers to prevent dies from being damaged or dislodged by accidental physical contact. Of course, it would be possible to attach such clamping bars to more than one edge of the support sheet for additional strength and security.

The apertures 20 in the support sheet are preferably formed by stamping. Any burs or distortion around the lower edges of the apertures 20 may suitably be removed by grinding the rear surface of the support sheet 18.

The embodiment of FIG. 5 differs from the previously described embodiments in that most of the holes 84 in the support sheet 18 are of smaller diameter than the holes 14 in the bed 12 of the press. Only some of the holes are of the same size or larger than the holes in the bed of the press and these serve to receive dogs 16 or 16′ as described above to secure the support sheet 18 to the bed 12. The smaller holes 84 are intended for fixing the dies 10a to the support sheet 18. Instead of self-tapping screws 22 engaging in the support sheet, nut inserts 82 are mounted in the holes 84 using a rivet gun and bolts are screwed into these nuts. As the holes 84 are aligned with the holes 14 in the bed of the press, the nut inserts can be allowed to protrude into the holes 14 and this makes for a stronger fixing.

As an alternative to screwing through holes in the dies 10, it is possible to form the edges of the dies with a step and to employ a clamping plate 86 to grip the step at the periphery of the die 10a and press it against the support sheet 18. If the clamping plate 86 is provided with an upstand, as shown, then it remains flat as the bolt 80 passing through it is tightened in a nut insert 82. The hole in the clamping plate 86 for receiving the bolt 80 may be elongated to allow for variation in the distance of the edge of the die 10a from the centre of the nut 82.

1. A method of positioning dies on the bed of a press, which comprises providing a support plate to overlie the surface of the bed of the press and having through apertures in alignment with anchoring holes formed in the bed of the press, placing individual dies in desired positions over the support plate, anchoring the dies and the support plate to the bed of the press by inserting and tightening dogs into the aligned apertures in the support plate and anchoring holes in the bed and securing the dies to the support plate.

2. A method as claimed in claim 1, wherein the dies are secured to the support sheet in a manner that permits a limited degree of lost motion.

3. A method as claimed in claim 2, wherein the dies are secured to the support sheet by drilling holes in the dies and inserting screws through the holes in the dies into the support sheet, the shanks of the screws being a loose fit in the holes in the dies.

4. A die assembly for forming multiple impressions on a carrier, the assembly comprising a plurality of individual dies secured in predetermined positions to a common support plate, the support plate having a matrix of apertures for receiving dogs for retaining the die assembly on the bed of a press.

5. A die assembly as claimed in claim 4, wherein the combined thickness of the dies and the support plate is substantially 6.35 mm, namely the thickness of the a conventional die.

6. A die assembly as claimed in claim 5, wherein the dies should have a thickness of 4.35 mm and the support plate a thickness of 2 mm.
